(19) United States
(12) Patent Application Publication
(10) Pub. No.: US 2013/0268373 A1
(43) Pub. Date: Oct. 10, 2013

(54) METHODS AND SYSTEMS FOR PRESENTING PERSONALIZED ADVERTISEMENTS

(71) Applicant: Michael Grishaver, Portola Valley, CA (US)

(72) Inventor: Michael Grishaver, Portola Valley, CA (US)

(73) Assignee: Linkedln Corporation, Mountain View, CA (US)

(21) Appl. No.: 13/439,719

(22) Filed: Apr. 4, 2012

(51) Int. Cl. G06Q 30/02

(52) U.S. Cl. 705/14.67

(57) ABSTRACT

Techniques for personalizing a display advertisement for presentation to a member of a social network service are described. When a member of a social network service requests and receives web-based content, via a web-based (e.g., web browser) client application, an ad request is communicated to a social network service. The ad request is processed by identifying an online job listing that is likely to be of interest to the member of the social network service. A display advertisement is then personalized to present information from both the selected online job listing, and the member profile of the member who will be viewing the display advertisement.

### TECHNICAL FIELD

The present disclosure generally relates to data processing systems. More specifically, the present disclosure relates to methods, systems and computer program products for personalizing an advertisement for presentation to a member of a social network service.

### BACKGROUND

A social network service is a computer- or web-based application that enables users to establish links or connections with persons for the purpose of sharing information with one another. Some social networks aim to enable friends and family to communicate with one another, while others are specifically directed to business users with a goal of enabling the sharing of business information. For purposes of the present disclosure, the terms “social network” and “social network service” are used in a broad sense and are meant to encompass services aimed at connecting friends and family (often referred to simply as “social networks”), as well as services that are specifically directed to enabling business people to connect and share business information (also commonly referred to as “social networks” but sometimes referred to as “business networks”).

With many social network services, members are prompted to provide a variety of personal information, which may be displayed in a member's personal web page. Such information is commonly referred to as personal profile information, or simply “profile information”, and when shown collectively, it is commonly referred to as a member's profile. For example, with some of the many social network services in use today, the personal information that is commonly requested and displayed includes a member's age, gender, interests, contact information, home town, address, the name of the member's spouse and/or family members, a photograph of the member, and so forth. With certain social network services, such as some business network services, a member's personal information may include information commonly included in a professional resume or curriculum vitae, such as information about a person's education, employment history, job skills, professional organizations, and so forth. With some social network services, a member's profile may be viewable to the public by default, or alternatively, the member may specify that only some portion of the profile is to be public by default with the entire profile only viewable by a select set of persons to whom the member has granted the appropriate authority. As such, many social network services serve as a sort of directory of people to be searched and browsed.

Because social network services are a rich source of information about people, job recruiters, human resource professionals, and others working in the job recruitment and placement industry frequently use social network services in an attempt to identify potential candidates to fill certain job openings. However, in many instances the best candidates for a particular job opening are passive candidates, who are actively engaged, employed and contributing at another organization. These passive candidates are also the most difficult to identify and recruit as they are not actively networking and/or sending out resumes in search of new positions. Skilled recruiters are continuously seeking out new methods and tools to market their job openings to these passive job seekers.

### DESCRIPTION OF THE DRAWINGS

Some embodiments are illustrated by way of example and not limitation in the FIG.s of the accompanying drawings, in which:

FIG. 1 is a block diagram illustrating various components of a social network system having an advertisement server for presenting personalized display advertisements, consistent with some embodiments of the invention;

FIG. 2 is a block diagram showing an example of the flow of data that occurs in a computer network environment that includes a social network system, such as that illustrated in FIG. 1, when a personalized job-related display advertisement is presented, consistent with some embodiments;

FIG. 3 is a flow diagram illustrating an example of the method operations involved in a method of establishing an advertising campaign with which job-related display advertisements are presented to members of a social network service, according to some embodiments of the invention;

FIG. 4 is a flow diagram illustrating an example of the method operations involved in a method of processing an advertisement request to display a personalized display advertisement, according to some embodiments of the invention;

FIGS. 5, 6 and 7 are user interface illustrations showing examples of job-related display advertisements, consistent with some embodiments of the invention; and

FIG. 8 is a block diagram of a machine in the form of a computing device within which a set of instructions, for causing the machine to perform any one or more of the methodologies discussed herein, may be executed.

### DETAILED DESCRIPTION

The present disclosure describes methods, systems and computer program products for personalizing a display advertisement for presentation to a member of a social network service in connection with the presentation of a web page or some other web-based content. In the following description, for purposes of explanation, numerous specific details are set forth in order to provide a thorough understanding of the various aspects of different embodiments of the present invention. It will be evident, however, to one skilled in the art, that the present invention may be practiced without all of the specific details.

Consistent with some embodiments of the present invention, a social network service includes an advertisement service that allows a company, recruiter, or any other person or organization, to target members of the social network service based on their member profile attributes and characteristics, and present the targeted members with advertisements relating to job listings for available employment positions. Accordingly, when a member of the social network service requests an item of web-based content (e.g., a web page) using a conventional web browser application, or some other proprietary application, the member may be presented with web-based content that includes a display advertisement that has been personalized for the member and presents information relating to a job listing for an employment position with a particular company or organization.

The particular job listing that is selected for presentation to the member of the social network service via the display advertisement is selected based on results of a matching operation performed by a matching or recommendation engine. For example, the matching or recommendation engine extracts or otherwise receives various attributes or characteristics of the member profile of the member to whom the display advertisement is to be presented, and then compares the member profile attributes and/or characteristics with information included in, or otherwise associated with, a plurality of job listings from a particular company, organization, or individual. As such, an attempt is made to present the viewer with a job-related advertisement showing information relating to the best or most interesting job listing for the viewer, based on various attributes or characteristics of the viewer's member profile. Accordingly, the matching or recommendation engine selects the best job listing of the many job listings associated with the company, organization, person or other entity that has qualified to have a job-related display advertisement presented to the viewer in connection with the presentation of the web-based content. The display advertisement is then customized to include information from, or associated with, the particular selected job listing.

In addition to personalizing the job-related advertisement to include select information from a job listing that is most likely to be of interest to the viewer, with some embodiments, the job-related display advertisement is personalized by including in the display advertisement one or more items of information from the member's profile. For example, the display advertisement may include a picture or photograph of the person to whom the display advertisement is being presented. With some embodiments, the display advertisement may feature a graphic or picture representing an employee badge that includes a photograph of the viewer alongside text that reads similar to, “John, imagine yourself as a software engineer at Widgets, Inc.” By personalizing the display advertisement to include information about an open employment position that has been selected for presentation to the member based on an analysis of the member's own member profile, and by including in the display advertisement some personal information from the member's profile, the display advertisement is far more likely to capture the member's attention. Consequently, the personalized display advertisement is far more likely to meet with success in attracting qualified candidates for a company's open employment positions.

By way of example, suppose John Smith is a member of a social network service and has indicated in his member profile that he is currently employed as a senior level software engineer at a company in the consumer electronics space with the name, ACME Products. John may or may not be actively looking for a new employment position. Widgets, Inc., a company that is also in the consumer electronics space is looking to fill several open employment positions for senior level software engineers. With an embodiment of the present invention, a recruiter for the company, Widgets, Inc., can target members of the social network service (like John) with just a few steps.

First, the recruiter for Widgets, Inc. generates one or more job listings for the open employment position or positions for which the recruiter is attempting to attract candidate employees. With some embodiments of the invention, the job listings can be generated via a job listing service offered in connection with the social network service. However, in alternative embodiments, the one or more job listings may be generated using a third-party job listing service—that is, a job listing service hosted and provided by an entity other than the entity operating the social network service. In generating the job listing or listings, the recruiter may specify various desired attributes or characteristics that an ideal candidate is likely to have for each job listing. For instance, the recruiter may specify the desired industry, current job title, geographic location, and so forth, for an ideal candidate. These attributes and characteristics can be used by the recommendation or matching engine to determine the likelihood that a particular member of the social network service, based on his or her member profile attributes and characteristics, is likely to have an interest in a particular employment position, and thus, a particular job listing.

After the recruiter for Widgets, Inc. has generated the relevant job listing or listings with a job listing service, the recruiter then establishes an advertising campaign with the social network service. The exact manner in which this is done may vary from one implementation to the next. For instance, with some embodiments, the social network service may offer a self-service portal that operates in conjunction with an advertisement server and provides the recruiter with various user interfaces through which the recruiter can select or otherwise designate the necessary advertising campaign parameters. On the other end of the spectrum, the recruiter may contact a representative of the social network service (e.g., by e-mail or telephone) to communicate or otherwise convey the requisite advertising campaign parameters, which the representative will then use to establish the advertising campaign on behalf of the recruiter or company. In general, the advertising campaign parameters might include any number and variety of parameters that define how an online advertising campaign is to operate. In particular, the advertising campaign parameters may identify the job listings that are to be considered for presentation to members of the social network service in job-related advertisements. For instance, this may be achieved by simply specifying a company identifier (ID) with which a set of job listings is also associated. Alternatively, if the job listings are hosted by a third party job listing service (e.g., a job listing service that is not hosted by, or otherwise associated with, the social network service), the job listings may be identified by some other means, such as a uniform resource locator (URL) of a web page including a job listing. In some instances, the third-party job listing service may provide a publically accessible application programming interface (API) via which the job listing information for the particular company can be accessed.

Additionally, the advertising campaign parameters may specify the various web pages, or web-based content, with which the job-related advertisements are to appear. The content may be identified specifically (e.g., with a URL), or by subject matter or topic. With some embodiments, the web pages or web-content with which the job-related advertisements may appear will be those associated with the various applications and services provided by the social network service. In other embodiments, various third-party content providers may host the web pages or web content with which the job-related advertisements are to appear. The advertising campaign parameters may also include a price (e.g., a bid price) the recruiter is willing to pay per impression of a display advertisement, as well as the time frame during which the advertising campaign is to be active. The recruiter for Widgets, Inc may also specify a variety of other campaign parameters. Once the recruiter has established the job listings and the advertising campaign is established and activated, job-related advertisements are presented to members of the social network service when those members are viewing certain content.

Continuing with the example, suppose the recruiter for Widgets, Inc. has generated a job listing for a senior level software engineering position and specified that job-related advertisements are to be presented on the member profile pages of the members of the social network service who are currently employed at Widgets, Inc. When John Smith requests the member profile page of his good friend and former boss, who is now employed at Widgets, Inc, John may be presented with a job-related display advertisement for a software engineering position at Widgets, Inc. In particular, the display advertisement may be personalized to include information from the particular senior level software engineer job listing for Widgets, Inc., and information from John's member profile. For example, the advertisement may include a picture or photograph of John (from John's profile) within a graphic of an employee badge, with text similar to, “John, imagine yourself as a software engineer at Widgets, Inc.” The exact member profile information that is extracted and presented with the display advertisement will vary from one implementation to the next. When John selects or otherwise interacts with the display advertisement, for example, by manipulating a cursor control device or touching a touch screen display, additional information about the job listing, or additional information about the company on whose behalf the job listing has been posted, may be presented. For example, with some embodiments, the display advertisement may include a link to the actual job listing, to a company web page hosted by the social network service, or to a website operated by the company.

With some embodiments, in addition to displaying information extracted from the viewer's member profile as part of the display advertisement, the job-related display advertisement may also include information concerning one or more connection paths connecting, via the social graph maintained by the social network service, the viewer of the advertisement with one or more other members of the social network service who have some association with the company at which the employment position is available. For example, with some embodiments, in preparing the display advertisement, an analysis of the social graph maintained by the social network service may be undertaken to identify members in the viewer's social network who are, or have been, employed at the particular company whose job listing is being highlighted in the job-related display advertisement. Accordingly, the job-related display advertisement may include information about the members who are in the viewer's extended social network (i.e., connected via the social graph) and who are, or have been, employed at the company offering the employment position via the selected job listing that is being highlighted in the advertisement. With some embodiments, by simply selecting (e.g., with a cursor control device, or touch screen display) a graphical representation of a connected member, the viewer can initiate communication with the connected member to inquire about the company generally, and the job listing in particular. A variety of other advantages will be readily apparent from the description of the figures that follow.

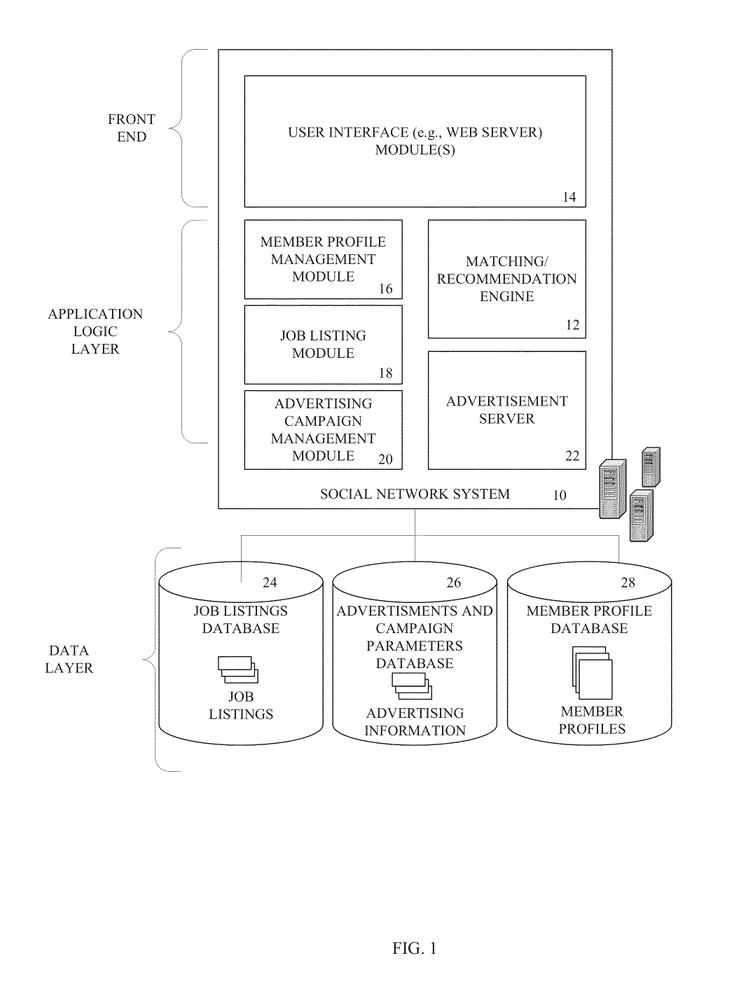

FIG. 1 is a block diagram illustrating various components of a social network system 10 having an advertisement server 22 for presenting personalized display advertisements, consistent with some embodiments of the invention. As shown in FIG. 1, the social network system 10 is generally based on a three-tiered architecture, consisting of a front-end layer, application logic layer, and data layer. As is understood by skilled artisans in the relevant computer and Internet-related arts, each module or engine shown in FIG. 1 represents a set of executable software instructions and the corresponding hardware (e.g., memory and processor) for executing the instructions. To avoid obscuring the inventive subject matter with unnecessary detail, various functional modules and engines that are not germane to conveying an understanding of the inventive subject matter have been omitted from FIG. 1. However, a skilled artisan will readily recognize that various additional functional modules and/or engines may be used with a social network system such as that illustrated in FIG. 1, to facilitate additional functionality that is not specifically described herein. Furthermore, the various functional modules and engines depicted in FIG. 1 may reside on a single server computer, or may be distributed across several server computers in various arrangements.

As shown in FIG. 1, the front end consists of a user interface module (e.g., a web server) 14, which receives requests from various client-computing devices, and communicates appropriate responses to the requesting client devices. For example, the user interface module(s) 14 may receive requests in the form of Hypertext Transport Protocol (HTTP) requests, or other web-based, application programming interface (API) requests. Accordingly, the user interface module(s) 14 will respond to such requests by communicating web-based content to a requesting device. In general, various applications and services of the social network service are accessed with a client-computing device executing a conventional web browser application. In addition, an application executing on a mobile computing device (e.g., smart phone, or tablet computing device) may also request and receive web-based content from the social network service.

The application logic layer includes the various application server modules, which, in conjunction with the user interface module(s) 14, generate various user interfaces (e.g., web pages) with data retrieved from various data sources in the data layer. With some embodiments, individual application server modules are used to implement the functionality associated with various applications, services and features of the social networking service. For example, the social network service may include a member profile management module 16. When invoked, the member profile management module 16 may display a member's profile information and allow for the editing of the member's profile information. Similarly, the member profile management module 16 may operate in conjunction with a search engine to allow users to search for and browse the member profiles of other members.

Also shown in FIG. 1 is a job listing module 18. The job listing module 18 implements an application or service that facilitates the posting, searching and browsing of job listings. For example, using the job listing module 18, a representative of a company or other organization can provide various information about a particular open employment position that a company is looking to fill. The job listing module 18 may prompt a user to provide such information as: a job title, a company name, a location, a job type (e.g., full time, contract, part time, etc.), an amount or level of experience that is desired, an industry, a particular job function, a desired compensation level, as well as a description of the primary job functions, or any other job-related information. Once the information has been provided and the appropriate payment has been made, the job listing is submitted and activated, making it searchable and viewable by users of the social network service.

Another application server module shown in FIG. 1 is the advertising campaign management module 20. With some embodiments, the advertising campaign management module 20 may have a user interface that is part of an advertising portal that is directly accessible to advertisers. However, in other embodiments, the advertising campaign management module 20 may be accessible only to various persons employed by or otherwise representing the social network service. In either case, the advertising campaign management module 20 facilities the establishment of advertising campaigns, which are used by the advertising server 22 to serve advertisements. Using the advertising campaign management module 20, a user can specify advertising campaign parameters for a particular campaign, including such information as: the name of an advertising campaign, the type of advertisements to be presented as part of the advertising campaign, the content (e.g., text and/or images) to appear in the advertisements of the advertising campaign, the web-based content (e.g., web pages) in which the advertisements are to appear, member profile targeting parameters (e.g., age, gender, groups, job titles, companies, and geography, among others), the price or bid amount the advertiser is willing to pay for each advertisement impression, a maximum amount the advertiser is willing to pay per day or for the campaign, the desired range of time that the advertising campaign is to be active, and so forth. With some embodiments, a particular advertising campaign can be established to serve a specific type of display advertisement, referred to generally herein as a job-related advertisement. When selecting a job-related advertisement, the advertiser may specify a particular set of job listings to be highlighted or presented in the job-related display advertisements that are presented to the members of the social network service. The job listings may be hosted by the social network service, or, with an external third-party job listing service.

Referring again to FIG. 1, in addition to the various application server modules, the social network system 10 includes various application services or engines that may be utilized by several different applications. One such engine is the matching or recommendation engine 12. With some embodiments, the matching or recommendation engine 12 is a general purpose engine that can be configured for use with any number of applications to provide recommendations relating to any number of recommendation entities. For purposes of the present disclosure, a recommendation entity is simply a collection of information organized around a particular concept that is supported by the social network service in general, and the matching or recommendation engine in particular. For instance, some examples of recommendation entities are: member profiles, jobs or job listings, interest groups, companies, advertisements, events, news, discussions, tweets, questions and answers, and so forth. Accordingly, with some embodiments, by specifying the particular features of two recommendation entities to be compared, and by specifying a particular algorithm for use in generating a similarity score for the two recommendation entities, the recommendation engine can be configured and customized to perform such tasks as: generate similarity scores for use in recommending job listings to a member; generate similarity scores for use in recommending particular interest groups that a user might be interested in joining; generate similarity scores for use in displaying an appropriate or relevant advertisement to a particular member, and many others.

Another service shown in FIG. 1 is the advertisement server 22. With some embodiments, the social network system 10 includes an advertisement server 22 that facilitates the serving of display advertisements that can be embedded within web-based content served by the social network service, and/or content served by various third-party content providers with whom the operator of the social network service has partnered. In general, a content provider will embed a tag or some other code within an Internet document. When a client-computing device requests and processes the Internet document, the processing of embedded tag will result in the client-computing device directing an advertisement request to the advertisement server 22. When the advertisement server receives an advertisement request from a client-computing device, the advertisement server will process the advertisement request to serve an advertisement in accordance with a set of advertising campaign parameters defined for an advertising campaign that is associated with the particular advertisement request.

As shown in FIG. 1, the data layer includes several databases for storing various types of information used by different applications of the social network service, including data associated with various recommendation entities, for example, such as job listings 24, display advertisements and associated campaign parameters 26, member profile information 28, and so forth. With some embodiments, some recommendation entity data is processed in the background (e.g., offline) to generate pre-processed entity data, which can be used by the recommendation engine, in real-time, to make recommendations generally, and to identify job listings that are likely of interest to a member, specifically. For example, a member's job title may be pre-processed to normalize the data and take into account situations in which the same title may be used in different industries to identify different jobs. In addition to the various databases shown in FIG. 1, other data may also be stored in the data layer. For example, a separate database (not shown) may store the social graph data structures for implementing the social graph that defines the various relationships between members and other entities represented in the social graph, such as companies, groups, educational institutions, and so forth. With some embodiments, the social graph is implemented as a set of nodes, connected by edges, where each node represents a social graph entity (e.g., a person, company, group, educations institution, etc.) and each edge that connects two nodes represents a particular type of association or relationship that exists between the two entities represented by the nodes.

Consistent with some embodiments, when a person initially registers to become a member of the social network service, the person will be prompted to provide some personal information, such as his or her name, age (e.g., birth date), gender, interests, contact information, home town, address, the names of the member's spouse and/or family members, educational background (e.g., schools, majors, etc.), current job title, job description, industry, employment history, skills, professional organizations, and so on. This information is stored as part of a member's profile, for example, in the database with reference number 28.

Once registered, a member may invite other members, or be invited by other members, to connect via the social network service. A “connection” may require a bi-lateral agreement by the members, such that both members acknowledge the establishment of the connection. Similarly, with some embodiments, a member may elect to “follow” another member. In contrast to establishing a “connection”, the concept of “following” another member typically is a unilateral operation, and at least with some embodiments, does not require acknowledgement or approval by the member that is being followed. When one member follows another, the member who is following may receive automatic notifications about various activities undertaken by the member being followed.

The social network service may provide a broad range of other applications and services that allow members the opportunity to share and receive information, often customized to the interests of the member. For example, with some embodiments, the social network service may include a photo sharing application that allows members to upload and share photos with other members. With some embodiments, members may be able to self-organize into groups, or interest groups, organized around a subject matter or topic of interest. With some embodiments, members may subscribe to or join groups affiliated with one or more companies. For instance, with some embodiments, members of the social network service may indicate an affiliation with a company at which they are employed, such that news and events pertaining to the company are automatically communicated to the members. With some embodiments, members may be allowed to subscribe to receive information concerning companies other than the company with which they are employed.

With some embodiments, the social network service facilitates a job listing service. For instance, when a person or company has one or more job openings for which they are seeking job candidates, a user interface of a job listing service allows one to specify various items of information about the job opening(s), as well as desired attributes and characteristics of an ideal candidate for the job opening. The information is then stored in a database 24 as a job listing, and is made accessible to other members of the social network service. Accordingly, members who are interested in job listings can browse, search and otherwise view and explore job listings. With some embodiments, a member can perform a search and/or register to be notified of new job listings, for example, by specifying particular attributes (e.g., job title, industry, geographic location, etc.) of job listings in which the member is interested. As described in greater detail below, to facilitate the presentation of job listings to passive job seekers—for example, members of the social network service who are not currently engaged in a job search—the social network service provides a special type of advertising campaign that enables the targeting of members with job-related advertisements showing details of a particular job listing selected based on a determination that the job listing is likely to be of interest to the viewing member.

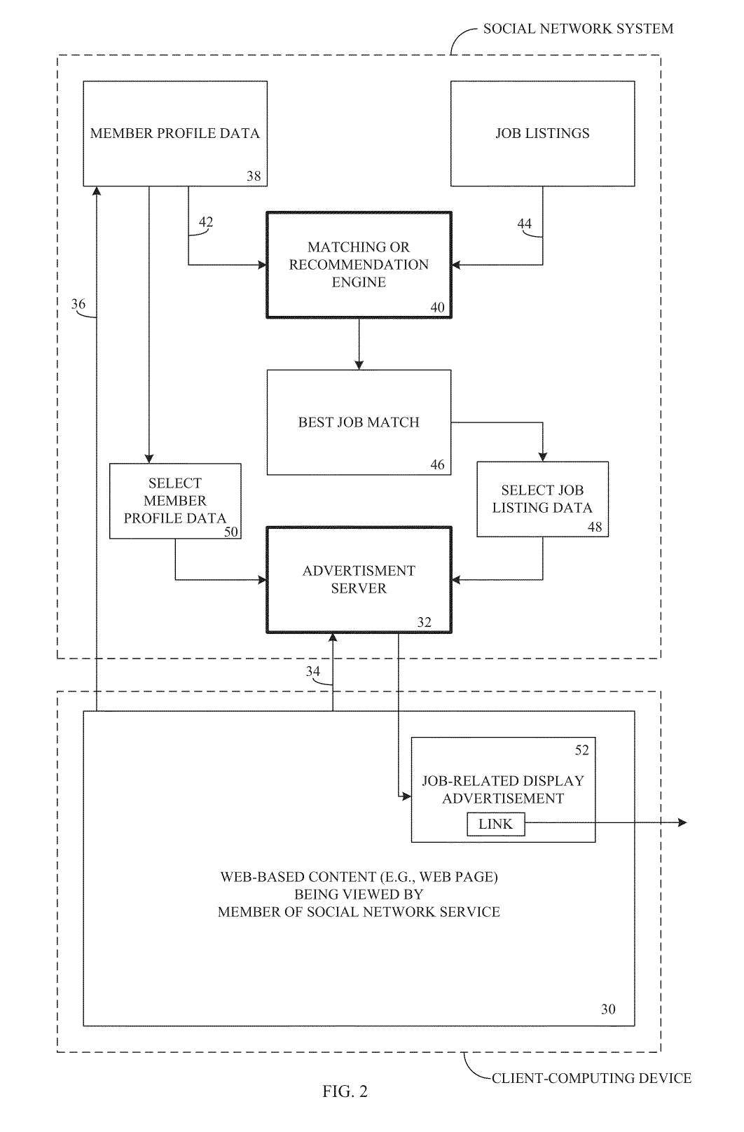

FIG. 2 is a block diagram showing an example of the flow of data that occurs in a computer network environment including a social network system, such as that illustrated in FIG. 1, when a personalized job-related display advertisement is presented, consistent with some embodiments. When a member of a social network service uses a web-based application (e.g., a web browser), or some other proprietary application (e.g., a web-based mobile application) to request web-based content (e.g., a web page), the web-based content will be communicated over the network to the client-computing device being operated by the member. In FIG. 2, the block with reference number 30 represents an example of such web-based content being displayed via a client-computing device. As the web browser or other proprietary application processes the received web-based content and encounters a tag associated with an embedded advertisement request, the client-computing device will communicate an advertisement request to the advertisement server 32 of the social network service. In FIG. 2, the arrow with reference number 34 represents this advertisement request being communicated from the client, to the advertisement server 32. In addition to, or, as part of the advertisement request, a member identifier that uniquely identifies the member of the social network service is also communicated to the social network service. In FIG. 2, the arrow with reference number 36 represents the communication of the member identifier to the social network service. In this example, the member identifier uniquely identifies the member associated with the member profile data having reference number 38.

After the advertisement server 32 receives the advertisement request 34, the advertisement server will determine which of any number of advertising campaigns qualifies for the presentation of a display advertisement in response to the request. For example, the advertisement server 32 may determine which of any number of advertisers has submitted the highest bid for the placement of an advertisement within the particular web page 30 being presented at the client-computing device. In the case where the selected advertising campaign involves the presentation of job-related display advertisements, a matching or recommendation engine 40 will be invoked to perform a matching or recommendation operation. For example, as illustrated in FIG. 2, the matching or recommendation engine represented with reference number 40 will receive as input certain elements of information extracted from the member profile data 38 of the member who is viewing the web page 30. In FIG. 2, the arrow with reference number 42 represents this input into the matching or recommendation engine 40. The matching or recommendation engine 40 then uses this extracted member profile data 42 during a matching or recommendation operation to analyze one or more job listings 44 associated with the advertising campaign, and to identify the one job listing that is best suited for presentation to the member of the social network service, based on similarities between attributes or parameters of the job listing 44 and the members' member profile attributes and/or characteristics. With some embodiments, each job listing analyzed by the matching or recommendation engine is assigned a score (e.g., a similarity score) representing a measure of probability or likeliness that the member will have an interest in the particular job listing. Once all of the job listings have been analysed and assigned a score, the job listing having the highest score is selected as the job listing most likely to be of interest to the member. Accordingly, the result of the matching algorithm is a particular job listing having the highest score that exceeds some threshold level or score. For example, in FIG. 2, the output of the matching algorithm is represented by the box labelled, “BEST JOB MATCH” having reference number 46.

If there is at least one job listing that is assigned a score that exceeds some predetermined threshold score, the advertisement server 32 generates a personalized display advertisement to include select information from the particular job listing 48 and select information from the member profile data 50. With some embodiments, the information selected for presentation in the display advertisement is determined by a display advertisement template, or other advertisement configuration information, that is specified for the particular advertising campaign. With some embodiments, several different display advertisement templates may be specified, such that a particular template is selected based on the available member profile information. For instance, if the member profile of the viewer of the advertisement does not include a photograph, the display advertisement selected for presentation may be based on a template that does not include a photograph. Finally, the personalized display advertisement is communicated to the client-computing device and displayed as an embedded advertisement in the original web-based content. In FIG. 2, the presented display advertisement is shown with reference number 52. With some embodiments, the display advertisement 52 may include one or more graphical user interface elements, such as buttons or hyperlinks, which facilitate additional functionality. For instance a link or button with the text, “APPLY NOW”, may serve as a link to a web page that enables the member to submit an application for the job listing that is presented in the display advertisement. Similarly, a link or button with the text, “SHARE THIS JOB”, may allow the member to share the job listing presented in the display advertisement with another member of the social network service.

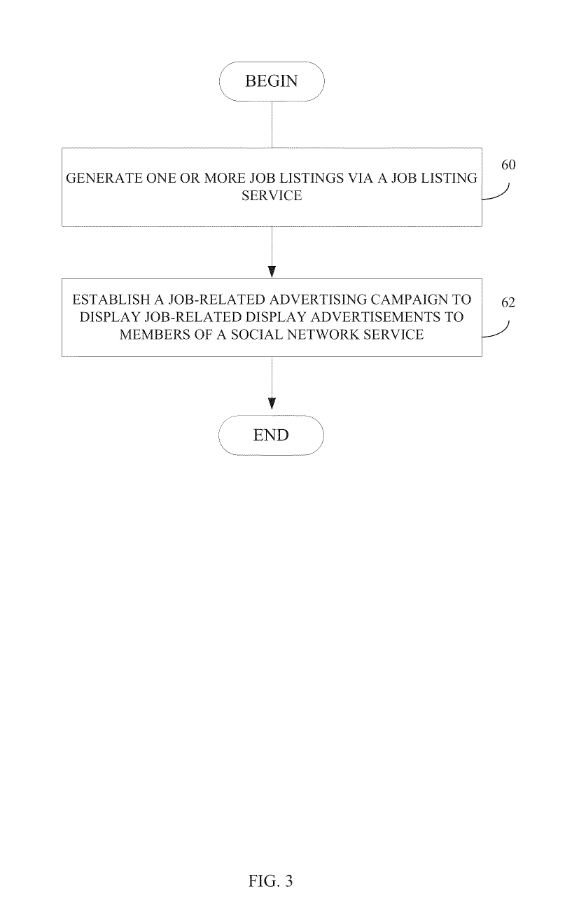

FIG. 3 is a flow diagram showing an example of the operations performed to establish a job-related advertising campaign, according to some embodiments of the invention. For purposes of the present disclosure, a job-related advertising campaign is any online advertising campaign that operates by serving job-related display advertisements consistent with the techniques described herein. As illustrated in FIG. 3, there are two primary operations or steps that are generally undertaken to establish a job-related advertising campaign, consistent with embodiments of the invention. First, as illustrated in FIG. 3 in connection with the operation with reference number 60, one or more job listings are generated. For example, a person acting on his or her own behalf, or on behalf of a company or another organization, will interact with a job listing service to provide information about one or more job openings. With some embodiments, the job listing service may be hosted and operated by a social network service. However, in other embodiments, the job listing service may be hosted and operated by a third-party (other than the owner or operator of the social network service). In any case, the information that is provided will be formatted and stored in the form of an online job listing, and in some instances, will be accessible, for example, via an application programming interface (API).

After the one or more job listings are generated, at method operation 62, an advertising campaign is established. In particular, a person representing the company or organization having the one or more job listings will establish an advertising campaign to target members of the social network service who may be interested in one or more of the job openings described in the job listings. As such, the various advertising campaign parameters may include various attributes and characteristics of member profiles that the advertiser desires in an ideal candidate. Some examples of these profile attributes and characteristics are: geographic location, current or past job titles, current or past industries, skills, educational institutions attended, professional certifications, and so forth.

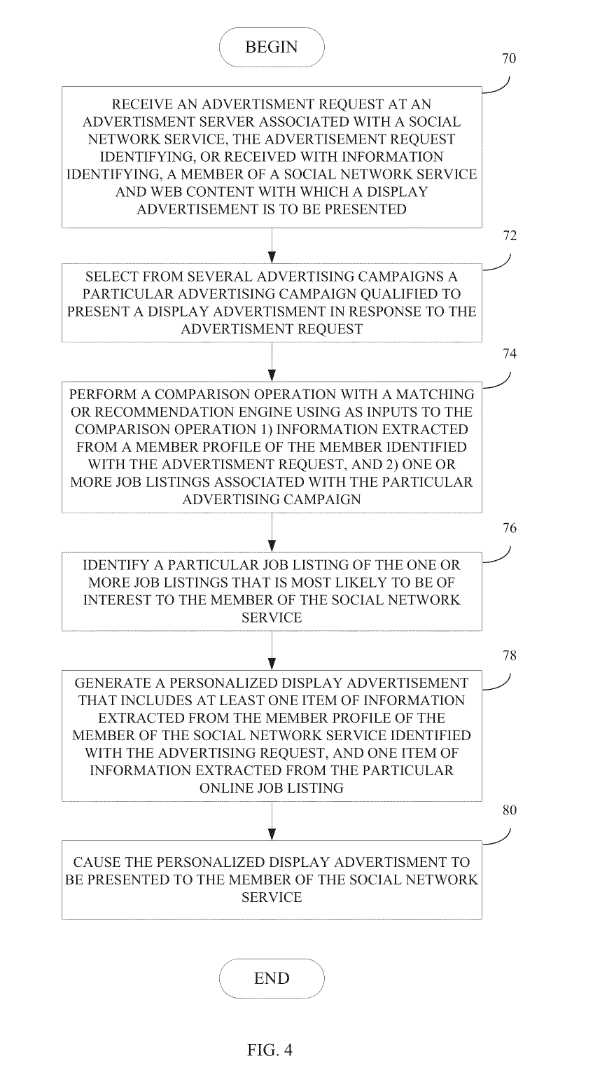

FIG. 4 is a flow diagram illustrating an example of the method operations involved in a method of processing an advertisement request to display a personalized display advertisement, according to some embodiments of the invention. At method operation 70, an advertisement server receives an advertisement request from a client-computing device. The request identifies, or is communicated with information that identifies, a member of a social network service as well as the web content with which a display advertisement is to be presented. Next, at method operation 72, the advertisement server selects from several advertising campaigns a particular advertising campaign that is determined to be qualified for the presentation of the display advertisement in response to the advertisement request. For example, the advertisement server may simply identify the advertising campaign that specifies the highest bid amount associated with the various parameters with which the advertisement request has been received. When the selected advertising campaign involves presentation of job related display advertisements, at method operation 74, a recommendation or matching engine is invoked to perform a matching or recommendation operation. In particular, at method operation 74, a matching or recommendation engine compares several elements extracted from the member profile of the member who is to view the advertisement with various parameters or attributes associated with each job listing. Based on the extent to which the select member profile information corresponds or matches the desired attributes for the job listing, the job listing is assigned a score, referred to herein as a similarity score. For example, the member profile attributes or characteristics may include, among others: a geographic location of the member, a job title of the member, an industry in which the member is employed, an academic degree or major of the member, and a professional association or certification of the member. A matching algorithm is used to assign each job listing for the selected company or organization a similarity score, indicating a measure of likelihood that the member would be interested in the respective job.

At method operation 76, a particular job listing from the one or more job listings analysed is selected. With some embodiments, the selection of the particular job listing is as simple as identifying the one job listing with the highest similarity score, as determined by the matching or recommendation engine. With some embodiments, a threshold score may be defined, such that, in order for a particular job listing to be presented to the member, the job listing must be assigned a similarity score that equals or exceeds the threshold score. When no job listing is assigned a similarity score that meets or exceeds the threshold score, a default or generic display advertisement may be presented to the member.

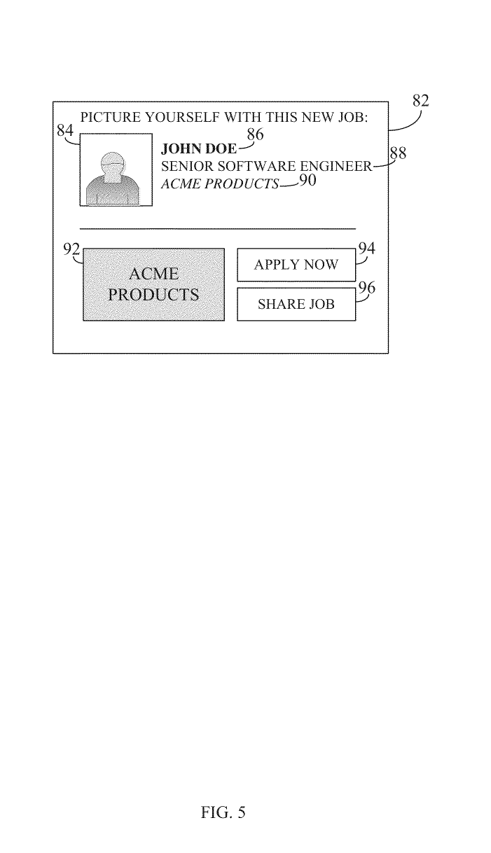

When there is at least one job listing that is assigned a similarity score that exceeds the threshold score, the job listing with the highest similarity score that exceeds the threshold score is selected for presentation to the member in a display advertisement. Accordingly, at method operation 78 the advertisement server generates a display advertisement that includes certain elements or items of information extracted from the selected job listing. In addition, the display advertisement is personalized to include one or more elements or items of information extracted from the member's member profile. For instance, the display advertisements presented and described in connection with FIGS. 5, 6 and 7 are examples. Finally, at method operation 80, the personalized display advertisement is communicated from the advertisement server to the client-computing device for presentation to the member of the social network service.

FIGS. 5, 6 and 7 are illustrations of user interfaces showing examples of job-related display advertisements, consistent with some embodiments of the invention. As illustrated in FIG. 5, the display advertisement 82 is generated to include elements or items of information from both the member's profile, and the job listing that has been selected as most relevant for the particular viewing member. In this instance, the name of the member (e.g., “JOHN DOE”, with reference number 84) and the photograph, with reference number 86, have been extracted from the member's profile information and included in the presentation of the display advertisement. Additionally, the job title, with reference number 88, the name of the company at which the job is available (e.g., ACME PRODUCTS, with reference number 90), and the company logo, with reference number 92, have been extracted from the selected job listing.

In addition to the elements of information extracted from the member's profile and from the job listing, the display advertisement 82 includes several interactive components. For example, the company logo 92 may be a hyperlink, which, when selected (e.g., with a pointing device, or touch screen display) causes a company page for ACME PRODUCTS to be presented to the viewer. The company page may be a web page hosted by the social network service, or hosted by a third-party server at the control of the company (e.g. ACME PRODUCTS). The button or link with the label, “APPLY NOW”, with reference number 94, when selected, will present the member with a web page that enables the member to submit a job application for the job listing. With some embodiments, various items of information from the member's profile can be used to pre-populate fields corresponding with information being requested by the company as part of the job application. Finally, the button or link with label, “SHARE JOB” and reference number 96, enables the member to forward the job-related display advertisement, or, the actual job listing from which the job-related information has been extracted, to another person. In particular, the information may be forwarded to another member of the social network service.

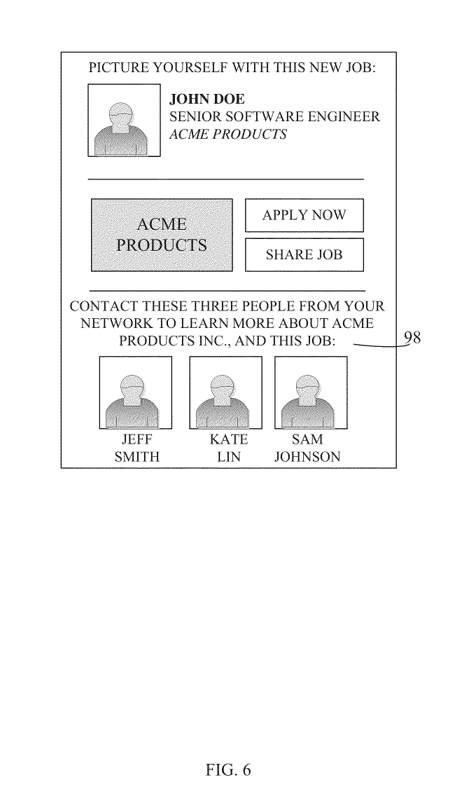

In addition to displaying as part of a job-related display advertisement information extracted from the viewing member's member profile, with some embodiments, the display advertisement may include information identifying members of the viewing member's social network, who have some association or relationship with the company at which the employment position is available. For instance, as illustrated in the example job-related display advertisement presented in FIG. 6, and indicated specifically with reference number 98, three members (e.g., JEFF, KATE and SAM) have been identified as having some association or relationship with the company, ACME PRODUCTS, at which the senior software engineering position is available. These members of the social network service have been selected for presentation in the display advertisement because they are connected to the viewing member (e.g., JOHN DOE) via the social graph maintained by the social network service, and have some association or relationship with the company (e.g., ACME PRODUCTS) being highlighted in the advertisement. For example, the three members may be current or past employees of ACME PRODUCTS.

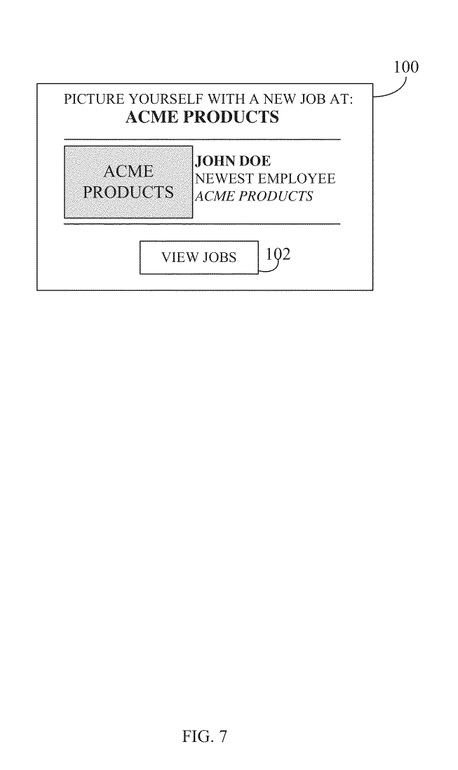

With some embodiments, when no particular job listing for a company or organization has a similarity score that equals or exceeds a threshold score, a default display advertisement that is not specific to any one job listing for the company may be presented to the member. For example, FIG. 7 illustrates just such an advertisement. In FIG. 7, the display advertisement with reference number 100 represents a default advertisement that might be displayed when no particular job listing is determined to have a similarity score that meets or exceeds some threshold score. In such a scenario, a default display advertisement may be displayed. In this example, the button or link with label, “VIEW JOBS”, with reference number 102, when selected, will present the member with a list of all job listings for the company, ACME PRODUCTS.

By generating a display advertisement to include elements of a member's very own member profile and with elements of a job listing, and then presenting the job-related display advertisement in the proper context (e.g., embedded within certain web pages), the resulting advertisements are far more likely to capture the attention of the viewer, and thus result in higher success rates for attracting qualifying candidates for open job positions. Additionally, by providing a member with information about who in the member's professional network may have an association or relationship with a company offering a particular employment position, the member viewing the display advertisement can take immediate action to obtain additional information about the company and/or job being highlighted in the display advertisement.

The various operations described in connection with the example methods set forth herein may be performed, at least partially, by one or more processors that are temporarily configured (e.g., by software) or permanently configured to perform the relevant operations. Whether temporarily or permanently configured, such processors may constitute processor-implemented modules or objects that operate to perform one or more operations or functions. The modules and objects referred to herein may, in some example embodiments, comprise processor-implemented modules and/or objects.

Similarly, the methods described herein may be at least partially processor-implemented. For example, at least some of the operations of a method may be performed by one or more processors or processor-implemented modules. The performance of certain operations may be distributed among the one or more processors, not only residing within a single machine or computer, but deployed across a number of machines or computers. In some example embodiments, the processor or processors may be located in a single location (e.g., within a home environment, an office environment or at a server farm), while in other embodiments the processors may be distributed across a number of locations.

The one or more processors may also operate to support performance of the relevant operations in a “cloud computing” environment or within the context of “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

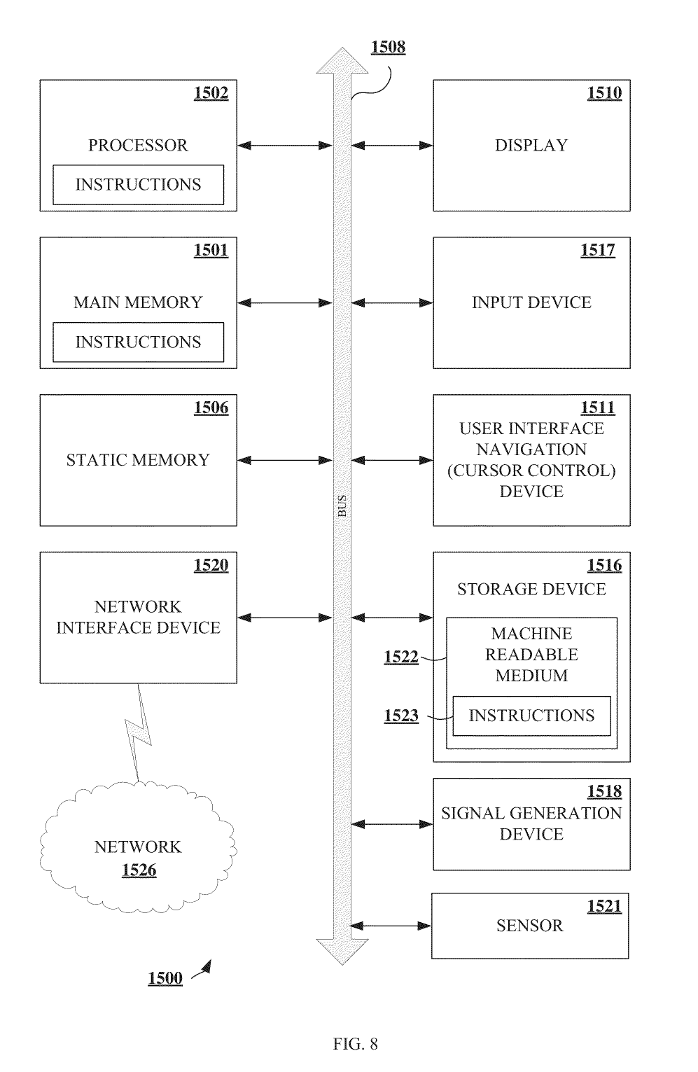

FIG. 8 is a block diagram of a machine in the form of a computer system within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a client-server network environment, or as a peer machine in peer-to-peer (or distributed) network environment. In a preferred embodiment, the machine will be a server computer, however, in alternative embodiments, the machine may be a personal computer (PC), a tablet PC, a set-top box (STB), a Personal Digital Assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1500 includes a processor 1502 (e.g., a central processing unit (CPU), a graphics processing unit (GPU) or both), a main memory 1501 and a static memory 1506, which communicate with each other via a bus 1508. The computer system 1500 may further include a display unit 1510, an alphanumeric input device 1517 (e.g., a keyboard), and a user interface (UI) navigation device 1511 (e.g., a mouse). In one embodiment, the display, input device and cursor control device are a touch screen display. The computer system 1500 may additionally include a storage device 1516 (e.g., drive unit), a signal generation device 1518 (e.g., a speaker), a network interface device 1520, and one or more sensors 1521, such as a global positioning system sensor, compass, accelerometer, or other sensor.

The drive unit 1516 includes a machine-readable medium 1522 on which is stored one or more sets of instructions and data structures (e.g., software 1523) embodying or utilized by any one or more of the methodologies or functions described herein. The software 1523 may also reside, completely or at least partially, within the main memory 1501 and/or within the processor 1502 during execution thereof by the computer system 1500, the main memory 1501 and the processor 1502 also constituting machine-readable media.

While the machine-readable medium 1522 is illustrated in an example embodiment to be a single medium, the term “machine-readable medium” may include a single medium or multiple media (e.g., a centralized or distributed database, and/or associated caches and servers) that store the one or more instructions. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

The software 1523 may further be transmitted or received over a communications network 1526 using a transmission medium via the network interface device 1520 utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wi-Fi® and WiMax® networks). The term “transmission medium” shall be taken to include any intangible medium that is capable of storing, encoding or carrying instructions for execution by the machine, and includes digital or analog communications signals or other intangible medium to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

1. A method comprising:
receiving, from a client-computing device, an advertisement request that includes information identifying a member of a social network service and information identifying web content in which an advertisement is to be presented;
performing a comparison operation with a processor-implemented recommendation engine using as inputs to the comparison operation i) information extracted from a member profile of the member of the social network service identified in the advertisement request, and ii) information specified in one or more online job listings for employment positions with an organization;
based on results of the comparison operation, identifying a particular online job listing of the one or more online job listings that is most likely to be of interest to the member of the social network service;
generating a personalized display advertisement that includes at least one item of information extracted from the member profile of the member of the social network service and one item of information extracted from the particular online job listing; and
causing the personalized display advertisement to be presented at the client-computing device.

2. The method of claim 1, further comprising:
as part of the comparison operation, assigning a similarity score to each of the one or more online job listings for employment positions with the organization, wherein identifying a particular online job listing of the one or more online job listings that is most likely to be of interest to the member of the social network service includes identifying the one online job listing that is assigned the highest similarity score that equals or exceeds a predetermined threshold score.

3. The method of claim 2, further comprising:
determining that no online job listing has been assigned a similarity score that equals or exceeds the predetermined threshold score; and
causing a default display advertisement to be presented instead of the personalized display advertisement at the client-computing device.

4. The method of claim 1, wherein the data elements extracted from the member profile of the member of the social network service and used as input to the comparison operation include any one, or any combination, of: a geographic location of the member, a job title of the member, an industry in which the member is employed, an academic degree or major of the member, and a professional association or certification of the member.

5. The method of claim 1, wherein generating a personalized display advertisement includes customizing the display advertisement to include any one, or any combination, of the following data elements extracted from the member profile of the member who initiated the request: the name of the member, a picture of the member, a job title of the member, an industry in which the member is employed, an academic degree or major of the member, and a professional association or certification of the member.

6. The method of claim 1, wherein generating a personalized display advertisement includes customizing the display advertisement to include any one, or any combination, of the following elements specified as part of, or associated with, the particular online job listing: a hyperlink to a web page including the particular online job listing, a hyperlink to a web page having a user interface that facilitates applying for the employment position identified in the particular online job listing, a hyperlink to a company page of the organization having the employment position identified in the particular online job listing, a job title for the employment position described in the particular online job listing, and an industry specified in the particular online job listing.

7. The method of claim 1, wherein the information identifying web content in which an advertisement is to be presented is information identifying web content hosted and served by the social network service.

8. The method of claim 1, wherein the information identifying web content in which an advertisement is to be presented is information identifying web content hosted and served by a third party content provider.

9. The method of claim 1, wherein the personalized display advertisement is a graphical representation of an employee badge for the organization having the employment position identified in the particular online job listing and customized to include the name and/or a photograph from the member profile of the member of the social network service identified in the advertisement request.

10. The method of claim 1, further comprising:
analyzing a social graph maintained by the social network service to identify one or more additional members of the social network service who i) are associated with the member of the social network service identified in the advertisement request, and ii) have an association or relationship with the organization associated with the particular online job listing; and
generating the personalized display advertisement to include information identifying the one or more additional members of the social network service.

11. A system comprising:
at least one processor for executing instructions;
a memory device in communication with the at least one processor and storing instructions, which, when executed by the at least one processor, are to:
receive, from a client-computing device, an advertisement request that includes information identifying a member of a social network service and information identifying web content in which an advertisement is to be presented;
perform a comparison operation using as inputs to the comparison operation i) information extracted from a member profile of the member of the social network service identified in the advertisement request, and ii) information specified in one or more online job listings for employment positions with an organization;
based on results of the comparison operation, identify a particular online job listing of the one or more online job listings that is most likely to be of interest to the member of the social network service;
generate a personalized display advertisement that includes at least one item of information extracted from the member profile of the member of the social network service and one item of information extracted from the particular online job listing; and
cause the personalized display advertisement to be presented at the client-computing device.

12. The system of claim 11, comprising instructions, which, when executed by the at least one processor, are to:
assign a similarity score to each of the one or more online job listings for employment positions with the organization; and
identify the one online job listing that is assigned the highest similarity score that equals or exceeds a predetermined threshold score.

13. The system of claim 12, comprising instructions, which, when executed by the at least one processor, are to:
determine that no online job listing has been assigned a similarity score that equals or exceeds the predetermined threshold score; and
cause a default display advertisement to be presented instead of the personalized display advertisement at the client-computing device.

14. The system of claim 11, wherein the data elements to be extracted from the member profile of the member of the social network service and used as input to the comparison operation include any one, or any combination, of: a job title of the member, an industry in which the member is employed, an academic degree or major of the member, and a professional association or certification of the member.

15. The system of claim 11, wherein the personalized display advertisement to be generated includes any one, or any combination, of the following data elements extracted from the member profile of the member who initiated the request: the name of the member, a picture of the member, a job title of the member, an industry in which the member is employed, an academic degree or major of the member, and a professional association or certification of the member.

16. The system of claim 11, wherein the personalized display advertisement to be generated includes any one, or any combination, of the following elements specified as part of, or associated with, the particular online job listing: a hyperlink to a web page including the particular online job listing, a hyperlink to a web page having a user interface that facilitates applying for the employment position identified in the particular online job listing, a hyperlink to a company page of the organization having the employment position identified in the particular online job listing, a job title for the employment position described in the particular online job listing, and an industry specified in the particular online job listing.

17. The system of claim 11, wherein the information identifying web content in which an advertisement is to be presented is information identifying web content hosted and served by the social network service.

18. The system of claim 11, wherein the information identifying web content in which an advertisement is to be presented is information identifying web content hosted and served by a third party content provider.

19. The system of claim 11, wherein the personalized display advertisement is a graphical representation of an employee badge for the organization having the employment position identified in the particular online job listing and customized to include the name and/or a photograph from the member profile of the member of the social network service identified in the advertisement request.

20. The system of claim 11, comprising instructions, which, when executed by the at least one processor, are to:
analyze a social graph maintained by the social network service to identify one or more additional members of the social network service who i) are associated with the member of the social network service identified in the advertisement request, and ii) have an association or relationship with the organization associated with the particular online job listing; and
generate the personalized display advertisement to include information identifying the one or more additional members of the social network service.
